(19) United States
(12) Patent Application Publication
(10) Pub. No.: US 2023/0377542 A1
(43) Pub. Date: Nov. 23, 2023

(54) ELECTRONIC MUSICAL INSTRUMENT, MUSIC DATA PROCESSING METHOD, AND NON-TRANSITORY COMPUTER READABLE MEDIUM

(71) Applicant: Roland Corporation, Shizuoka (JP)

(72) Inventor: Ryo Susami, Shizuoka (JP)

(73) Assignee: Roland Corporation, Shizuoka (JP)

(21) Appl. No.: 18/306,970

(22) Filed: Apr. 25, 2023

(30) Foreign Application Priority Data
May 18, 2022 (JP) 2022-081326

(51) Int. Cl. G10H 1/00; G10H 1/14; G10H 1/34; G10H 1/18

(52) U.S. Cl. CPC G10H 1/0008; G10H 1/0066; G10H 1/14; G10H 1/34; G10H 1/18; G10H 2240/311; G10H 2220/221

(57) ABSTRACT

An electronic musical instrument includes: a keyboard, including a key that allows automatic operation; a data acquisition part, acquiring music data in which one or more channels are provided and performance information containing a timbre is set for each channel; a selector, selecting a channel set with high timbre priority, in which the timbre priority is priority based on the timbre set in the performance information and is set for each channel contained in the music data acquired by the data acquisition part; and an automatic operation part, automatically operating the key of the keyboard based on the performance information of the channel selected by the selector in the music data acquired by the data acquisition part.

### CROSS-REFERENCE TO RELATED APPLICATION

This application claims the priority benefit of Japan Application No. 2022-081326, filed on May 18, 2022. The entirety of the above-mentioned patent application is hereby incorporated by reference herein and made a part of this specification.

### BACKGROUND

### Technical Field

The disclosure relates to an electronic musical instrument, a music data processing method, and a music data processing program.

### Related Art

Japanese Patent Laid-Open No. 2001-209379 discloses an electronic musical instrument in which a sound production start instruction and a sound production stop instruction are acquired from an external sequencer via a MIDI interface, and, as a musical tone is generated and emitted by a sound production control part, a key is operated (automatically operated) by a key drive control part by a solenoid in synchronism with emission of the musical tone. Accordingly, it is possible to make it appear to a user as if the musical tone was emitted in response to the automatic operation of the key.

In MIDI data, a plurality of channels are provided, and performance information such as a timbre to be sounded or the sound production start instruction and the sound production stop instruction is set for each of the channels. Conventionally, among the channels of the MIDI data, a set specific channel is used as a channel for operating the above-mentioned key. However, depending on the MIDI data, a timbre that does not constitute a main melody, such as timbre of bass, may be set for the above-mentioned set specific channel. In such a case, since the main melody of the emitted musical tone and the operation of the key do not match, the user may experience a feeling of incongruity.

### SUMMARY

The disclosure provides an electronic musical instrument, a music data processing method, and a music data processing program, in which a user's feeling of incongruity on automatic operation of a key of a keyboard using music data can be reduced.

An electronic musical instrument according to the disclosure is provided with a keyboard including a key that allows automatic operation. The electronic musical instrument includes: a data acquisition part, acquiring music data in which one or more channels are provided and performance information containing a timbre is set for each channel; a selector, selecting a channel set with high timbre priority, in which the timbre priority is priority based on the timbre set in the performance information and is set for each channel contained in the music data acquired by the data acquisition part; and an automatic operation part, automatically operating the key of the keyboard based on the performance information of the channel selected by the selector in the music data acquired by the data acquisition part.

A music data processing method according to the disclosure is a method for executing predetermined processing based on music data in which one or more channels are provided and performance information containing a timbre is set for each channel. The music data processing method includes the following. In a data acquisition step, the music data is acquired. In a selection step, a channel set with high timbre priority is selected, in which the timbre priority is priority based on the timbre set in the performance information and is set for each channel contained in the music data acquired in the data acquisition step. In a processing execution step, the predetermined processing is executed based on the performance information of the channel selected in the selection step in the music data acquired in the data acquisition step.

A music data processing program according to the disclosure is a program for causing a computer to execute predetermined processing based on music data in which one or more channels are provided and performance information containing a timbre is set for each channel. The music data processing program causes the computer to execute: a data acquisition step of acquiring the music data; a selection step of selecting a channel set with high timbre priority, in which the timbre priority is priority based on the timbre set in the performance information and is set for each channel contained in the music data acquired in the data acquisition step; and a processing execution step of executing the predetermined processing based on the performance information of the channel selected in the selection step in the music data acquired in the data acquisition step.

### BRIEF DESCRIPTION OF THE DRAWINGS

FIG. 1 illustrates an appearance of an electronic piano.

FIG. 2A and FIG. 2B illustrate a channel configuration of MIDI data.

FIG. 3 is a functional block diagram of an electronic piano.

FIG. 4 is a block diagram illustrating an electrical configuration of an electronic piano.

FIG. 5A schematically illustrates a priority timbre table, FIG. 5B schematically illustrates a priority CH table, and FIG. 5C schematically illustrates a timbre score table.

FIG. 6 is a flowchart of main processing.

FIG. 7 is a flowchart of timbre setting processing.

FIG. 8 is a flowchart of timbre setting processing in a modification.

### DESCRIPTION OF THE EMBODIMENTS

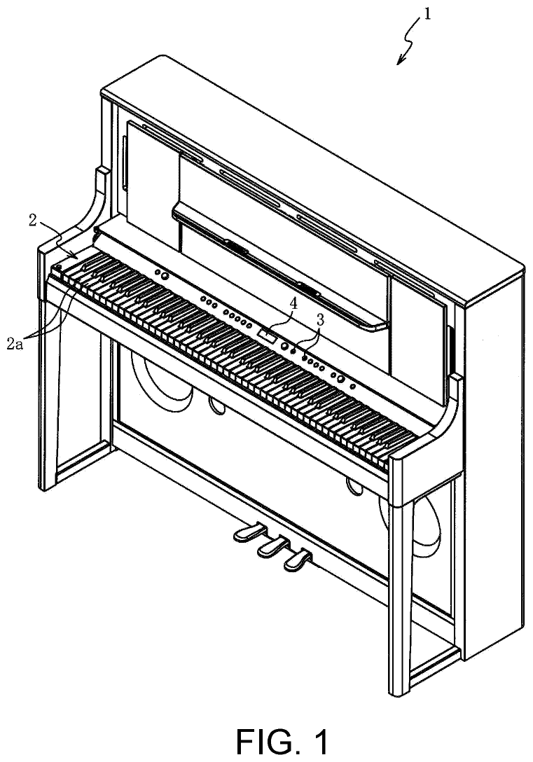

Hereinafter, an embodiment will be described with reference to the accompanying drawings. First, an overview of an electronic piano 1 of the present embodiment is described with reference to FIG. 1. FIG. 1 illustrates an appearance of the electronic piano 1. The electronic piano 1 is an electronic musical instrument that produces a musical tone based on a performance of a user H, or a musical tone based on Musical Instrument Digital Interface (MIDI) data MD being music data conforming to the MIDI standard.

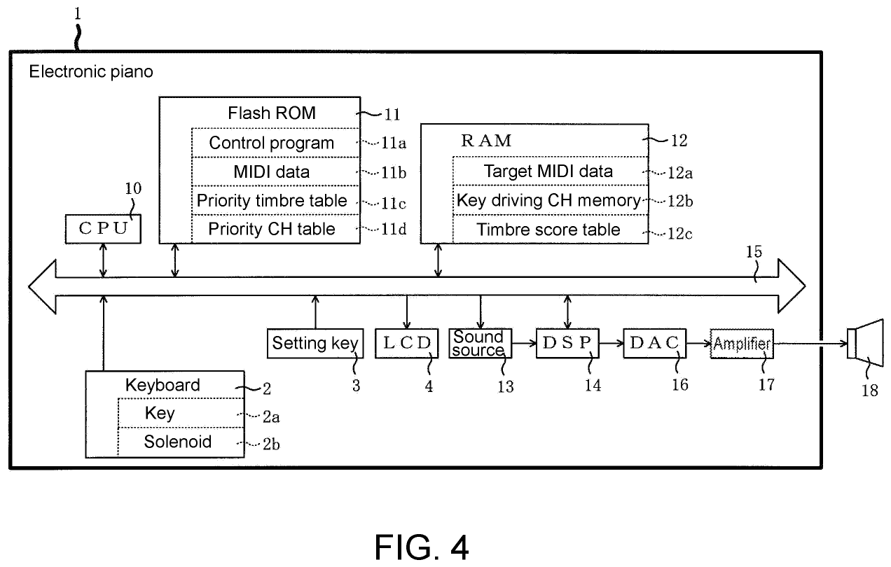

The electronic piano 1 is mainly provided with a keyboard 2, a setting key 3 to which various settings from the user H are input, and an LCD 4 displaying a setting state of the various settings or the like. The keyboard 2 is an input device for acquiring performance information according to the performance of the user H. The keyboard 2 is provided with a plurality of keys 2a. The performance information conforming to the MIDI standard, which corresponds to a key depression/key release operation on the key 2a by the user H, is output to a CPU 10 (see FIG. 4) and is output as a musical tone.

The keyboard 2 is provided with a solenoid 2b that independently drives each key 2a up and down. When a note-on event is executed in the MIDI data MD specified by the user H, by driving the key 2a downward by the solenoid 2b, depression of the key 2a is realized. On the other hand, when a note-off event is executed in the MIDI data MD, by driving the key 2a upward by the solenoid 2b, release of the key 2a is realized.

By synchronizing the depression/release of the key 2a by the solenoid 2b based on the MIDI data MD specified by the user H with production of a musical tone according to the MIDI data MD, it is possible to make it appear to the user H as if the electronic piano 1 is automatically playing. Hereinafter, such an act of driving the solenoid 2b based on the MIDI data MD to operate the key 2a is referred to as “automatic operation of the key 2a”.

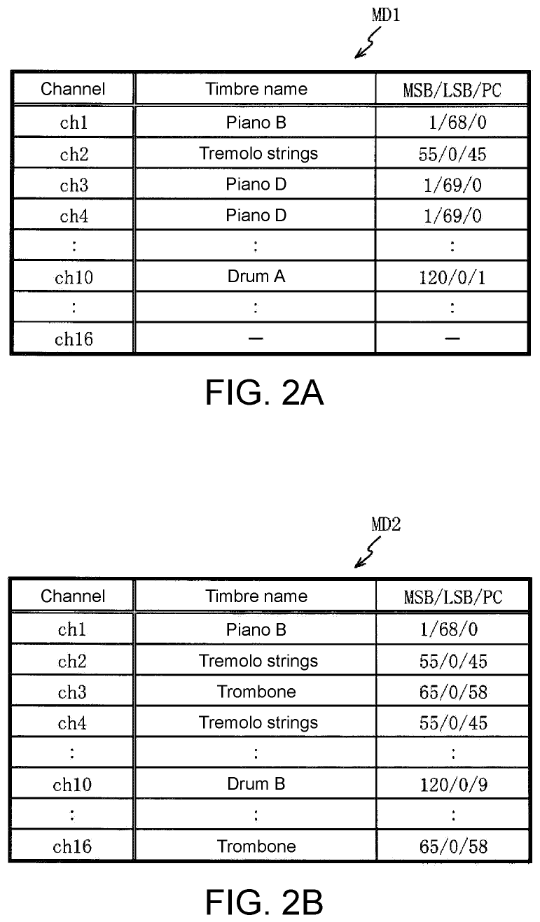

One or more channels are provided in the MIDI data MD, and performance information such as timbre or note-on/note-off is set for each channel. Hence, it is necessary to select from the channels contained in the MIDI data MD a channel containing specific performance information such as, for example, a main melody of a left-hand part and a right-hand part in a piano performance, and set the channel as a channel for automatically operating the key 2a. In the present embodiment, such channel selection is performed based on the timbre in the performance information of the channel. An overview of the channel selection in the present embodiment is described with reference to FIG. 2A to FIG. 2B.

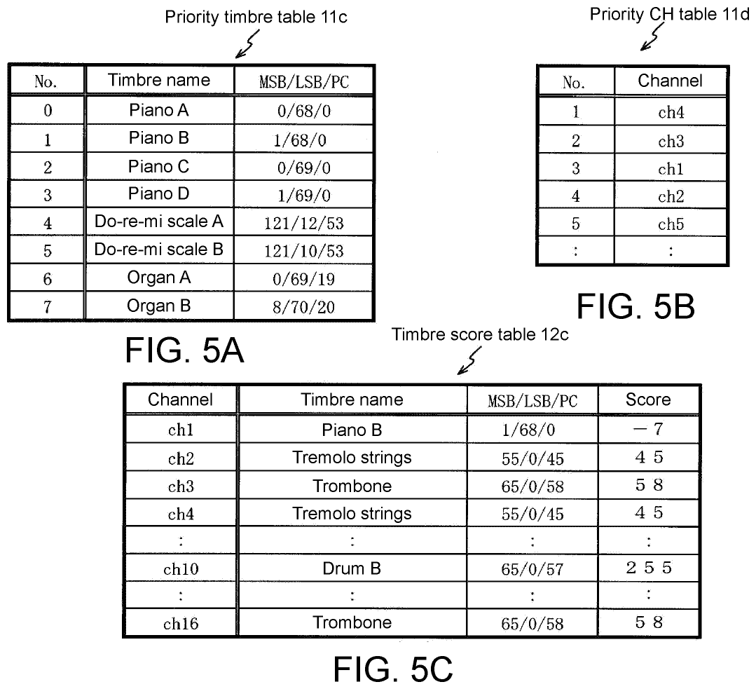

FIG. 2A illustrates a channel configuration of MIDI data MD1, and FIG. 2B illustrates a channel configuration of another MIDI data, denoted by MD2. In the MIDI data MD of the present embodiment, sixteen channels denoted by ch1 to ch16 are provided, each of which is set with performance information. In the MIDI data MD, the performance information does not have to be set for all of ch1 to ch16, and may be set for the number of channels corresponding to a musical piece. In FIG. 2A to FIG. 2B, and FIG. 5A to FIG. 5C to be described later, “—” indicates that the channel is not set with performance information. The number of channels provided in the MIDI data MD is not limited to sixteen, and may be sixteen or more or sixteen or less.

A combination of bank information and a program number (PC) for identifying each timbre set in the MIDI data MD is predetermined. “MSB” representing the most significant bit and “LSB” representing the least significant bit are provided as the bank information. An integer of 0 to 127 is set for each of the MSB, the LSB and the program number. A timbre is identified by the combination of the MSB, the LSB and the program number (PC).

In FIG. 2A to FIG. 2B and FIG. 5A to FIG. 5C, the MSB, the LSB and the program number of the timbre set for each channel of the MIDI data MD are expressed in the form of “MSB/LSB/program number (PC)”. For example, for ch1 of the MIDI data MD1 of FIG. 2A, a timbre having the MSB of “1”, the LSB of “68”, and a program number of “0” is set, and “piano B” corresponds to such a timbre. For ch3 of the MIDI data MD2 of FIG. 2B, a timbre having the MSB of “65”, the LSB of “0”, and a program number of “58” is set, and “trombone” corresponds to such a timbre.

From the MIDI data MD like this, the channel for automatically operating the key 2a is selected. In the related art, ch3 and ch4 of the MIDI data MD are selected as the channel for automatically operating the key 2a. This is because ch3 and ch4 of the MIDI data MD are often associated with the left-hand part and the right-hand part that constitute the main melody of the piano performance. For example, in the MIDI data MD1 of FIG. 2A, ch3 and ch4 are each set with “piano D” in order to correspond to the left-hand part and the right-hand part of the piano performance.

However, as described above, in the MIDI data MD, a timbre of a channel can be set according to the musical piece. For example, as in the MIDI data MD2 of FIG. 2B, while “piano B” that constitutes the main melody is set for ch1, “trombone” and “tremolo strings” are set for ch3 and ch4 respectively. In the MIDI data MD2 like this, if ch3 and ch4 are uniformly set as the channel for automatically operating the key 2a, there may be a discrepancy between the main melody of the musical tone generated based on the MIDI data MD2 and the automatic operation of the key 2a, giving the user H a feeling of incongruity.

Accordingly, in the present embodiment, a priority timbre table 11c (FIG. 5A) to be described later is provided in which timbre priority is set. The timbre priority is the priority of the timbre set for the channel for automatically operating the key 2a. Among the channels of the MIDI data MD, a channel set with a timbre having high timbre priority in the priority timbre table 11c is acquired and is set as the channel for automatically operating the key 2a.

Thus, no matter how the timbres of the channels in the MIDI data MD are assigned, the timbre having high timbre priority, for example, the timbre constituting the main melody, is set for the channel for automatically operating the key 2a. Accordingly, since the main melody of the musical tone generated based on the MIDI data MD can be matched with the automatic operation of the key 2a, the feeling of incongruity experienced by the user H due to the generated musical tone and the automatic operation can be reduced.

If the timbre contained in the MIDI data MD is not set in the priority timbre table 11c, a value corresponding to the program number (PC) of the corresponding timbre is set as the timbre priority. Specifically, the smaller the program number of the timbre, the higher the timbre priority is set. A timbre that may constitute the main melody, such as piano or organ, is often assigned as a timbre having a small program number in the MIDI data MD. Accordingly, by setting high timbre priority for a channel of a timbre having a small program number, the timbre that may be set for the main melody can be set with a good probability for the channel for automatically operating the key 2a.

Apart from the above-mentioned MIDI data MD created with ch3 and ch4 as the main melody, there is also MIDI data MD in which the same timbre is set for a plurality of channels and a specific channel among the channels is further built as the main melody. In the present embodiment, a priority CH table 11d (FIG. 5B) to be described later is provided in which channel priority being priority of a channel to be selected is set. In the case where the same timbre priority is set for a plurality of channels in the MIDI data MD, among these channels, a channel having high channel priority in the priority CH table 11d is set as the channel for automatically operating the key 2a.

Accordingly, channels of the main melody of the MIDI data, which have the same timbre and are specific channels, can be selected with a good probability as the channel for automatically operating the key 2a.

Furthermore, as in the above related art, in the case where the same timbre as the main melody is set for ch3 and ch4 of the MIDI data MD, and the same timbre priority is set for ch3 and ch4, regardless of the timbre priority of other channels, ch3 and ch4 are set as the channel for automatically operating the key 2a. Accordingly, when the key 2a is automatically operated with the MIDI data MD created with ch3 and ch4 as the main melody, ch3 and ch4 can be set as the channel for automatically operating the key 2a.

Such an operation is not limited to the case where the same timbre priority is set for ch3 and ch4. For example, in the case where the same timbre priority is set for a plurality of other channels such as ch6 and ch7, these channels may be set as the channel for automatically operating the key 2a.

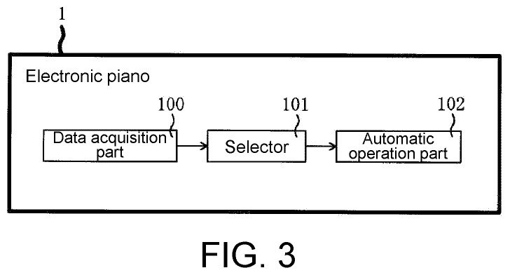

Next, a function of the electronic piano 1 is described with reference to FIG. 3. FIG. 3 is a functional block diagram of the electronic piano 1. As shown in FIG. 3, the electronic piano 1 includes a data acquisition part 100, a selector 101 and an automatic operation part 102.

The data acquisition part 100 is a means of acquiring the MIDI data MD, and is realized by the CPU 10 described later with reference to FIG. 4. The selector 101 is a means of selecting a channel set with high timbre priority, in which the timbre priority is the priority based on the timbre set in the performance information and is set for each channel contained in the MIDI data MD acquired by the data acquisition part. The selector 101 is realized by the CPU 10. The automatic operation part 102 is a means of automatically operating the key 2a of the keyboard 2 based on the performance information of the channel selected by the selector 101 in the MIDI data MD acquired by the data acquisition part 100, and is realized by the CPU 10.

In the MIDI data MD, the performance information for automatically operating the key 2a is selected based on the timbre priority of the timbre set in the performance information of the channel. Thus, since the automatic operation of the key 2a can be performed based on the channel of the timbre having high timbre priority and constituting the main melody in the MIDI data MD, the feeling of incongruity of the user H on the automatic operation can be reduced.

Next, an electrical configuration of the electronic piano 1 is described with reference to FIG. 4 and FIG. 5. FIG. 4 is a block diagram illustrating an electrical configuration of the electronic piano 1. The electronic piano 1 includes the CPU 10, a flash ROM 11, a RAM 12, the above-mentioned keyboard 2, setting key 3 and LCD 4, a sound source 13, and a digital signal processor 14 (hereinafter referred to as “DSP 14”), each of which is connected via a bus line 15.

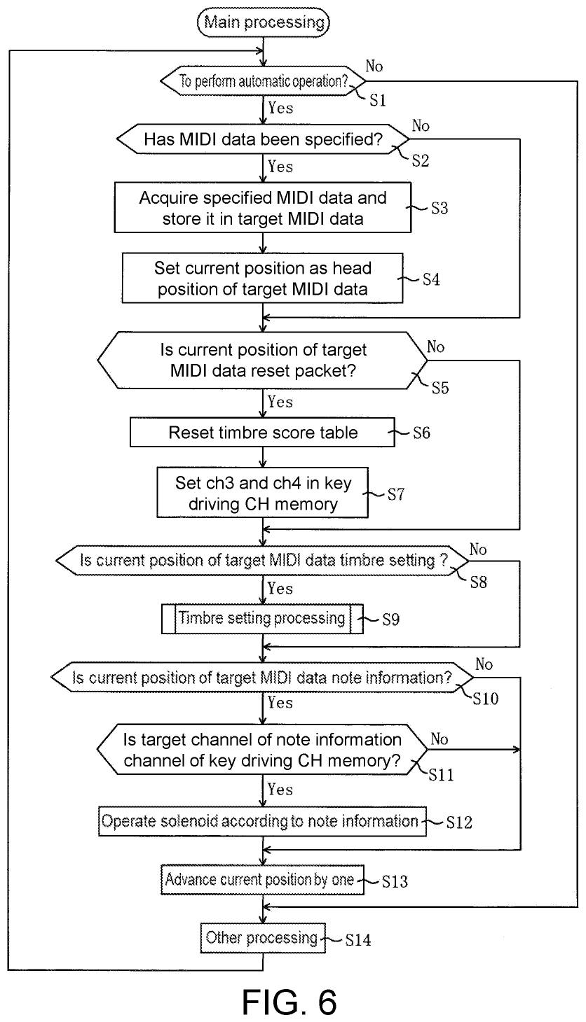

The CPU 10 is an arithmetic unit that controls each part connected by the bus line 15. The flash ROM 11 is a rewritable non-volatile storage device storing programs executed by the CPU 10 or fixed value data or the like, and the flash ROM 11 includes a control program 11a, MIDI data 11b in which a plurality of MIDI data MD is stored, the priority timbre table 11c, and the priority CH table 11d. When the control program 11a is executed by the CPU 10, main processing of FIG. 6 is executed. The priority timing table 11c and the priority CH table 11d are described with reference to FIG. 5A and FIG. 5B.

FIG. 5A schematically illustrates the priority timing table 11c. The priority timbre table 11c stores timbre names, bank information and program numbers (MSB/LSB/PC) of timbres in descending order of the timbre priority mentioned above. In FIG. 5A, the priority timbre table 11c stores eight timbres from the 0th (No. 0) timbre to the 7th (No. 7) timbre in descending order of timbre priority.

Specifically, in the priority timing table 11c, a timbre of piano (piano A to D) that is often used as the main melody, a timbre for solfege (do-re-mi scale A and B) for vocalizing a do-re-mi scale, and a timbre of organ (organ A and B) are stored. The timbres are stored in the 0th to 7th positions of the priority timbre table 11c in order of “timbre of piano→timbre for solfege→timbre of organ”, so that among the timbres, the timbre of piano has the highest timbre priority, the timbre of organ has the lowest timbre priority, and the timbre priority of the timbre for solfege is between the timbre priority of the timbre of piano and the timbre priority of the timbre of organ.

The number of timbres stored in the priority timbre table 11c may be eight or less or eight or more. The order (that is, the order of timbre priority) stored in the priority timbre table 11c is not limited to the order of “timbre of piano→timbre for solfege→timbre of organ”. For example, other orders, such as “timbre of piano→timbre of organ→timbre for solfege” or “timbre for solfege timbre of piano→timbre of organ”, may be used. Furthermore, the priority timbre table 11c may not only store the timbre of piano, the timbre of organ, and the timbre for solfege, and may also store timbres of other musical instruments such as a wind instrument (such as flute) or a stringed instrument (such as guitar and violin).

FIG. 5B schematically illustrates the priority CH table 11d. The priority CH table 11d stores channels in descending order of the channel priority mentioned above. In the present embodiment, as shown in FIG. 5B, the channel priority is set high in the priority CH table 11d for ch4 that may be used as the right-hand part and ch3 that may be used as the left-hand part in a piano performance. Accordingly, the channel that may be used as the right-hand part or the left-hand part that constitutes the main melody can be set with a good probability as the channel for automatically operating the key 2a.

The order of channel priority in the priority CH table 11d is not limited to that shown in FIG. 5B. The channel priority of ch3 and ch4 may be set low, and the channel priority of other channels (such as ch6) may be set high.

Please refer back to FIG. 4. The RAM 12 is a memory for rewritably storing various work data or flags or the like when the CPU 10 executes a program, and the RAM 12 includes target MIDI data 12a, a key driving CH memory 12b, and a timbre score table 12c. The target MIDI data 12a stores the MIDI data MD of a target for the automatic operation of the key 2a or the output of musical tones. The key driving CH memory 12b stores a channel for automatically operating the key 2a in the MIDI data MD of the target MIDI data 12a. The timbre score table 12c is described with reference to FIG. 5C.

FIG. 5C schematically illustrates the timbre score table 12c. The timbre score table 12c stores the timbre name, bank information and program number (MSB/LSB/PC), and score of the timbre corresponding to each channel of the target MIDI data 12a. The score in the timbre score table 12c is a value based on the timbre priority of the corresponding timbre. Specifically, the higher the timbre priority, the smaller the value is set for the score.

Please refer back to FIG. 4. The sound source 13 is a device that outputs waveform data based on input performance information. The DSP 14 is an arithmetic unit for arithmetically processing the waveform data input from the sound source 13. A digital-to-analog converter (DAC) 16 is connected to the DSP 14, an amplifier 17 is connected to the DAC 16, and a speaker 18 is connected to the amplifier 17.

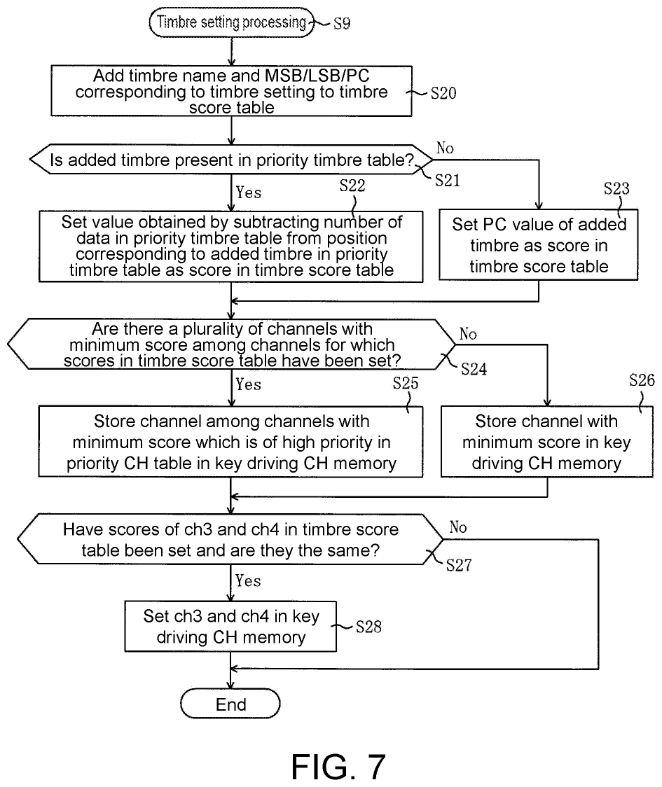

Next, processing executed by the CPU 10 of the electronic piano 1 will be described with reference to FIG. 6 and FIG. 7. FIG. 6 is a flowchart of the main processing. The main processing is the processing executed in the case where the electronic piano 1 is powered on. In the main processing, first, it is confirmed whether to perform the automatic operation of the key 2a (S1). In the present embodiment, whether or not to perform the automatic operation of the key 2a can be set by an operation of the user H on the setting key 3 (see FIG. 1), and a setting state thereof is confirmed in the processing of S1.

In the processing of S1, if the automatic operation of the key 2a is to be performed (S1: Yes), it is confirmed whether one piece of the MIDI data MD stored in the MIDI data 11b has been specified by an operation of the user H on the setting key 3 (S2).

In the processing of S2, if the MIDI data MD has been specified (S2: Yes), the specified MIDI data MD is acquired from the MIDI data 11b and stored in the target MIDI data 12a (S3). After the processing of S3, a current position being a reading position of the MIDI data MD stored in the target MIDI data 12a is set as a head position of the MIDI data MD (S4).

On the other hand, in the processing of S2, if the MIDI data MD has not been specified (S2: No), the processing of S3 and S4 is skipped.

After the processing of S2 and S4, it is confirmed whether the current position of the target MIDI data 12a is a reset packet (S5). In the present embodiment, the “reset packet” is “GM2SystemOn” or “GMSystemOn”. However, other packets may also be used.

In the processing of S5, if the current position of the target MIDI data 12a is a reset packet (S5: Yes), the timbre score table 12c is reset (S6), and ch3 and ch4 are set as an initial value in the key driving CH memory 12b (S7). In the present embodiment, resetting the timbre score table 12c refers to clearing the timbre name, bank information and program number of each channel in the timbre score table 12c (that is, setting “—” in FIG. 5C) and setting a value (for example, “255”) greater than the upper limit (for example, “127”) of the timbre priority for the score of each channel.

The initial value set in the key driving CH memory 12b in the processing of S7 is not limited to ch3 and ch4, and may be other channels.

In the case where a reset packet of the MIDI data MD is executed, there is a high possibility that a new timbre may be re-set for a channel after that. Accordingly, the timbre score table 12c is reset, and ch3 and ch4 as the initial value are set in the key driving CH memory 12b set based on the score in the timbre score table 12c. Accordingly, when the channel for automatically operating the key 2a is re-set based on the new timbre by the processing of S8 and S9 to be described later, a situation can be prevented in which the timbre that has been set for the channel so far may affect the re-setting of the new channel.

In the processing of S5, if the current position of the target MIDI data 12a is not a reset packet (S5: No), the processing of S6 and S7 is skipped.

After the processing of S5 and S7, it is confirmed whether the current position of the target MIDI data 12a is setting of timbre for a channel (S8). In the processing of S8, if the current position of the target MIDI data 12a is setting of timbre for a channel (S8: Yes), timbre setting processing (S9) is executed. Here, the timbre setting processing is described with reference to FIG. 7.

FIG. 7 is a flowchart of the timbre setting processing. In the timbre setting processing, first, the timbre name, bank information and program number of a timbre to be set are added to the timbre score table 12c (S20). Hereinafter, the timbre added to the timbre score table 12c in the processing of S20 is referred to as “added timbre”. After the processing of S20, it is confirmed whether the added timbre is present in the priority timbre table 11c (S21).

In the processing of S21, if the added timbre is present in the priority timbre table 11c (S21: Yes), a value obtained by subtracting the number (that is, “8”) of data of the priority timbre table 11c from a position corresponding to the added timbre in the priority timbre table 11c is set as a score (that is, timbre priority) of the added timbre in the timbre score table 12c (S22). For example, if the added timbre is “piano C”, since the position of piano C in the priority timbre table 11c is “2”, the score is “2-8”, namely, “−6”.

As shown in FIG. 5A, the positions of the timbres in the priority timbre table 11c of the present embodiment are set as follows. The position of the timbre having the highest timbre priority is set as “0”, and numbers are assigned in ascending order to the following. Thus, the position of “organ B” being the timbre having the lowest timbre priority in the priority timbre table 11c is “7”. Accordingly, since the score of the timbre included in the priority timbre table 11c is calculated by subtracting the number “8” of data of the priority timbre table 11c from the position of the corresponding timbre in the priority timbre table 11c, the score is always a negative value.

On the other hand, in the processing of S21, if the added timbre is not present in the priority timbre table 11c (S21: No), the program number of the added timbre is set as the score of the added timbre in the timbre score table 12c (S23).

After the processing of S22 and S23, it is confirmed whether a plurality of channels having a score of a minimum value (minimum score) are present among the channels in the timbre score table 12c for which the scores have been set (S24). In the processing of S24, if a plurality of channels having the minimum score are present (S24: Yes), among the channels having the minimum score, the channel having the highest channel priority in the priority CH table 11d is set in the key driving CH memory 12b (S25). On the other hand, in the processing of S24, if a plurality of channels having the minimum score are not present (S24: No), the channel having the minimum score is set in the key driving CH memory 12b (S26).

Here, in the timbre score table 12c, the score based on the priority timbre table 11c by the processing of S22 and the score based on the program number of the timbre by the processing of S23 may be mixed. As described above, the score based on the priority timbre table 11c is a negative value. On the other hand, since the program number of the timbre ranges from 0 to 127, the score based on the program number of the timbre is 0 or more.

Thus, in the case where the score based on the priority timbre table 11c and the score based on the program number of the timbre are mixed in the timbre score table 12c, the score based on the priority timbre table 11c is always less than the score based on the program number of the timbre. Accordingly, the timbre set in the priority timbre table 11c can be preferentially set or the channel for automatically operating the key 2a.

On the other hand, in the case where only the score based on the program number of the timbre is set in the timbre score table 12c, the channel having the smallest program number in the table is set as the channel for automatically operating the key 2a. Accordingly, since the channel of the timbre which is very likely to be set as the main melody of the musical tone and has the smallest program number can be set as the channel for automatically operating the key 2a, the feeling of incongruity between the output musical tone and the automatic operation, which is experienced by the user H, can be reduced.

After the processing of S25 and S26, it is confirmed whether the scores of ch3 and ch4 in the timbre score table 12c have been set and are the same (S27). In the processing of S27, if the scores of ch3 and ch4 have been set and are the same (S27: Yes), since it is determined that the same timbre is set for ch3 and ch4 and these channels constitute the main melody, ch3 and ch4 are set in the key driving CH memory 12b (S28).

On the other hand, in the processing of S27, if the scores of ch3 and ch4 have been set and are not the same (S27: No), the processing of S28 is skipped. After the processing of S27 and S28, the timbre setting processing is ended.

Please refer back to FIG. 6. In the processing of S8, if the current position of the target MIDI data 12a is not setting of timbre for a channel (S8: No), the timbre setting process (S9) is skipped. After the processing of S8 and S9, it is confirmed whether the current position of the target MIDI data 12a is note information (S10). In the processing of S10, if the current position of the target MIDI data 12a is note information (S10: Yes), it is confirmed whether a target channel of the note information is included in the channel of the key driving CH memory 12b (S11).

In the processing of S11, if the target channel of the note information is included in the channel of the key driving CH memory 12b (S11: Yes), the solenoid 2b is operated according to the note information (S12). For example, if the note information is note-on, the solenoid 2b is operated so that the key 2a to be note-on is pressed; if the note information is note-off, the solenoid 2b is operated so that the key 2a to be note-off is released. Although not illustrated, a musical tone corresponding to the note information of the current position is output along with the processing of S12.

On the other hand, if the current position of the target MIDI data 12a is not note information in the processing of S10 (S10: No), or if the target channel of the note information is not included in the channel of the key driving CH memory 12b in the processing of S11 (S11: No), or after the processing of S12, the current position of the target MIDI data 12a is advanced by one (S13).

In the processing of S1, if the automatic operation of the key 2a is not to be performed (S1: No), or after the processing of S13, other processing of the electronic piano 1 is executed (S14), and the processing of S1 onward is repeated. Examples of the “other processing” in the processing of S14 include output of a musical tone based on the note information of the current position of the target MIDI data 12a or output of a musical tone based on the performance of the key 2a by the user H.

Although the disclosure has been described based on the above embodiment, it can be easily inferred that various improvements or modifications may be made.

In the above embodiment, the electronic piano 1 is illustrated as an example of the electronic musical instrument. However, the disclosure is not limited thereto, and may be applied to other electronic musical instruments such as a synthesizer or an electronic wind instrument. For example, in the case of applying the disclosure to a synthesizer, a key of the synthesizer is made of a translucent material that transmits light, and an LED is provided inside the key. In the MIDI data MD of the target MIDI data 12a, if a note-on event occurs for the channel of the key driving CH memory 12b, the LED of the corresponding key may be turned on; if a note-off event occurs, the LED of the corresponding key may be turned off. Accordingly, a key to be fingered by the user H of the synthesizer and a timing of depression/release of the key can be presented by on/off of the LED.

The control program 11a may be executed by an information processing device such as a personal computer or a portable terminal. In this case, for example, a graphic of a musical instrument such as a piano is displayed on a display device of the personal computer or the like. In the MIDI data MD of the target MIDI data 12a, if a note-on event occurs for the channel of the key driving CH memory 12b, a mode of a graphic of the corresponding key of the musical instrument may be selected and displayed (for example, the corresponding white key or black key is red-colored); if a note-off event occurs, the selection and display of the mode of the graphic of the key may be canceled.

A musical score corresponding to each channel of the MIDI data MD of the target MIDI data 12a may be displayed on the display device, and a part corresponding to the channel of the key driving CH memory may be displayed in a different mode (for example in a different color) from the other parts in the musical score. Accordingly, a part constituting the main melody in the musical score can be presented to the user H. At this time, if the timbre of a specific musical instrument, for example, the timbre of violin, has been set with high timbre priority in the priority timbre table 11c, in the displayed musical score according to the MIDI data MD, since a part corresponding to the specific musical instrument (such as violin) is displayed in a different mode, the part can be clearly presented to the user H.

In the above embodiment, it is configured to acquire the MIDI data MD from the MIDI data 11b in the processing of S3 of FIG. 6. However, the disclosure is not limited thereto. For example, the electronic piano 1 may be provided with a communication device that communicates with an external device, and the MIDI data MD may be acquired from another device or the Internet via the communication device. In this case, the processing for automatic operation of a key or output of a musical tone is not necessarily performed after the entire MIDI data MD is acquired from another device or the Internet. For example, control signals of note information or the like that constitutes the MIDI data MD may be sequentially acquired from another device or the Internet, and the processing for automatic operation of a key or output of a musical tone may be sequentially performed based on the acquired control signals.

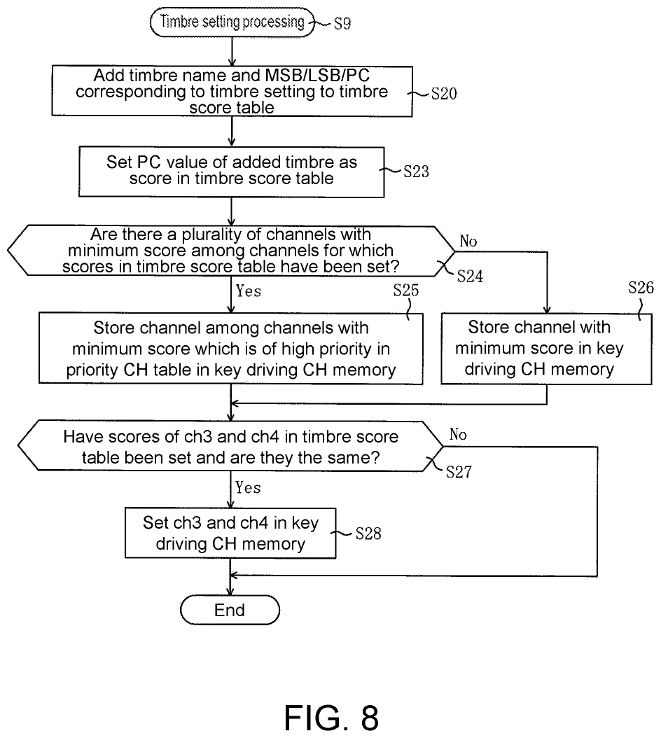

In the above embodiment, in the processing of S21 to S23 of FIG. 7, if the added timbre has been stored in the priority timbre table 11c, the corresponding timbre priority is set from the priority timbre table 11c; if the added timbre has not been stored, the timbre priority is set based on the program number of the added timbre. The disclosure is not limited thereto. The priority timbre table 11c may be omitted, and the timbre priority may always be set from the program number of the added timbre. In this case, as in the timbre setting processing in the modification of FIG. 8, after the processing of S20, the program number of the added timbre is set as the score of the added timbre in the timbre score table 12c by the processing of S23. After the processing of S23, the processing of S24 onward may be executed.

On the other hand, the timbre priority of all the timbres used by the electronic piano 1 may be stored in the priority timbre table 11c, and the timbre priority of the added timbre may always be set from the priority timbre table 11c.

Furthermore, in the processing of S23 of FIG. 7, the program number of the added timbre is set as the timbre priority. However, the disclosure is not limited thereto. For example, the timbre priority may be set based on the program number and bank information (MSB, LSB) of the added timbre. In this case, each of the program number, MSB and LSB of the added timbre may be multiplied by a predetermined coefficient, and a result obtained by further addition (that is, weighting operation) of the multiplication results may be set as the timbre priority. Accordingly, the timbre priority to be set can take into account the bank information as well as the program number of the added timbre.

In the above embodiment, both the program number and bank information of the timbre are stored in the priority timbre table 11c. However, the disclosure is not limited thereto. For example, the priority timbre table 11c may only store the program number of the timbre. In the processing of S21 of FIG. 7, if the program number of the added timbre matches a program number of a timbre (for example, “timbre X”) in which only the program number is set in the priority timbre table 11c, the timbre priority of the timbre X in the priority timbre table 11c may be set regardless of the bank information of the added timbre. In the MIDI data MD, since specific timbre such as piano or organ is often set with the same program number regardless of the position of the bank information, by setting only the program number in the priority timing table 11c in advance, there is no need to store the timbre for each bank information in the priority timing table 11c.

The priority timbre table 11c may store a mixture of the timbre having only the program number and the timbre according to the program number and the bank information, or the priority timbre table 11c may store only the timbre having the program number.

In the above embodiment, in the processing of S24 to S26 of FIG. 7, if there are a plurality of channels having the same timbre priority, a channel having the highest channel priority in the priority CH table 11d is selected as the channel for automatically operating the key 2a. However, the disclosure is not limited thereto. A plurality of channels (for example, channels having the highest and the second highest channel priority) having high channel priority in the channel priority table may be selected as the channel for automatically operating the key 2a. The processing of S24 to S26 may be omitted, and instead, all of a plurality of channels having the same timbre priority may be selected as the channel for automatically operating the key 2a.

In the above embodiment, in the processing of S27 and S28 of FIG. 7, if ch3 and ch4 have the same timbre priority, both ch3 and ch4 are selected as the channel for automatically operating the key 2a. However, the disclosure is not limited thereto. The processing of S27 and S28 may be omitted. Even if ch3 and ch4 have the same timbre priority, the channel for automatically operating the key 2a may be selected based on the timbre priority and the channel priority according to the processing of S24 to S26.

In the above embodiment, in the processing of S5 to S7 of FIG. 6, if the current position of the target MIDI data 12a is a reset packet, the timbre score table 12c is reset and the key driving CH memory 12b is set to the initial value. However, the disclosure is not limited thereto. The reset of the timbre score table 12c and the setting of the key driving CH memory 12b to the initial value may be performed, for example, immediately after power-on of the electronic piano 1 or immediately after the MIDI data MD is acquired by the processing of S3 of FIG. 6.

In the above embodiment, the automatic operation of the key 2a and the output of musical tones are performed based on the MIDI data of the target MIDI data 12a. However, the disclosure is not limited thereto. For example, in the electronic piano 1, while the automatic operation of the key 2a is performed based on the target MIDI data 12a, the output of musical tones may be omitted. Instead, a musical piece corresponding to the MIDI data of the target MIDI data 12a may be output from another device.

It is not necessary that musical tones are output from the sound source 13 or the like using the MIDI data of the target MIDI data 12a. For example, the electronic piano 1 may be provided with a string having a pitch corresponding to each key 2a and a hammer for striking the string, and musical tones may be output by sequentially striking, with the hammer, the strings having pitches corresponding to the note information contained in the MIDI data of the target MIDI data 12a.

In the above embodiment, the MIDI data MD is illustrated as an example of the music data. However, the disclosure is not limited thereto. Other music-related data other than that of the MIDI standard may be used as the music data.

What is claimed is:

1. An electronic musical instrument, comprising:
a keyboard, comprising a key that allows automatic operation;
a data acquisition part, acquiring music data in which one or more channels are provided and performance information containing a timbre is set for each channel;
a selector, selecting a channel set with high timbre priority, wherein the timbre priority is priority based on the timbre set in the performance information and is set for each channel contained in the music data acquired by the data acquisition part; and
an automatic operation part, automatically operating the key of the keyboard based on the performance information of the channel selected by the selector in the music data acquired by the data acquisition part.

2. The electronic musical instrument according to claim 1, further comprising:
a priority timbre storage part, storing the timbre priority corresponding to the timbre, wherein
the selector acquires, from the priority timbre storage part, the timbre priority corresponding to the timbre set in the performance information for each channel contained in the music data acquired by the data acquisition part, and selects the channel of a timbre that is high in terms of the timbre priority acquired.

3. The electronic musical instrument according to claim 1, wherein
the music data is MIDI data; and
the timbre priority is set higher as a program number of the timbre set in the performance information for each channel contained in the music data acquired by the data acquisition part is smaller, and the selector selects the channel set with high timbre priority.

4. The electronic musical instrument according to claim 1, further comprising:
a priority channel storage part, storing channel priority being priority of a channel selected in channel selection by the selector, wherein,
in response to same timbre priority being set for a plurality of the channels, the selector selects among the plurality of the channels the channel that is high in terms of the channel priority stored in the priority channel storage part.

5. The electronic musical instrument according to claim 4, wherein,
in the priority channel storage part, the channel priority of a predetermined channel corresponding to a left-hand part or a right-hand part in a piano performance is set high.

6. The electronic musical instrument according to claim 1, wherein
one or more channels are set as a specific channel; and
in response to same timbre priority being set for a plurality of the specific channels, the selector selects all of the corresponding specific channels as a channel for automatically operating the keyboard.

7. The electronic musical instrument according to claim 6, wherein
a predetermined channel corresponding to a left-hand part or a right-hand part in a piano performance is set as the specific channel.

8. The electronic musical instrument according to claim 1, wherein
the music data is MIDI data; and
the selector is executed in response to execution of a reset packet in the performance information of the music data.

9. The electronic musical instrument according to claim 1, further comprising:
a musical tone output part, outputting a musical tone based on the music data acquired by the data acquisition part.

10. The electronic musical instrument according to claim 2, wherein
the music data is MIDI data; and
the timbre priority is set higher as a program number of the timbre set in the performance information for each channel contained in the music data acquired by the data acquisition part is smaller, and the selector selects the channel set with high timbre priority.

11. A music data processing method, executing predetermined processing based on music data in which one or more channels are provided and performance information containing a timbre is set for each channel, wherein the music data processing method comprises:
acquiring the music data;
selecting a channel set with high timbre priority, wherein the timbre priority is priority based on the timbre set in the performance information and is set for each channel contained in the music data acquired; and
executing the predetermined processing based on the performance information of the channel selected in the music data acquired.

12. The music data processing method according to claim 11, further comprising:
storing the timbre priority corresponding to the timbre, wherein
the selecting comprises acquiring the timbre priority stored corresponding to the timbre set in the performance information for each channel contained in the music data acquired, and selecting the channel of a timbre that is high in terms of the timbre priority acquired.

13. The music data processing method according to claim 11, wherein
the music data is MIDI data; and
the timbre priority is set higher as a program number of the timbre set in the performance information for each channel contained in the music data acquired is smaller, and the selecting comprises selecting the channel set with high timbre priority.

14. The music data processing method according to claim 11, further comprising:
storing channel priority being priority of a channel selected in the selecting, wherein
the selecting comprises, in response to same timbre priority being set for a plurality of the channels, selecting among the plurality of the channels the channel that is high in terms of the channel priority stored.

15. The music data processing method according to claim 14, wherein
the channel priority of a predetermined channel corresponding to a left-hand part or a right-hand part in a piano performance is set high.

16. The music data processing method according to claim 11, wherein
one or more channels are set as a specific channel, wherein
the selecting comprises, in response to same timbre priority being set for a plurality of the specific channels, selecting all of the corresponding specific channels as a channel for automatically operating a keyboard.

17. The music data processing method according to claim 16, wherein
a predetermined channel corresponding to a left-hand part or a right-hand part in a piano performance is set as the specific channel.

18. The music data processing method according to claim 11, wherein
the music data is MIDI data; and
the selecting is executed in response to execution of a reset packet in the performance information of the music data.

19. The music data processing method according to claim 11, further comprising:
outputting a musical tone based on the music data acquired.

20. A non-transitory computer readable medium, storing a music data processing program that causes a computer to execute predetermined processing based on music data in which one or more channels are provided and performance information containing a timbre is set for each channel,
wherein the music data processing program causes the computer to:
acquire the music data;
select a channel set with high timbre priority, wherein the timbre priority is priority based on the timbre set in the performance information and is set for each channel contained in the music data acquired; and
execute the predetermined processing based on the performance information of the channel selected in the music data acquired.
